(19) United States
(12) Patent Application Publication
(10) Pub. No.: US 2008/0100601 A1
(43) Pub. Date: May 1, 2008

(54) LIQUID CRYSTAL DISPLAY DEVICE AND METHOD OF DRIVING THE SAME

(75) Inventors: Seung-Bin MOON, Seoul (KR); Bo-Young AN, Suwon-si (KR); Joo-Hyung LEE, Gwacheon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/925,767

(22) Filed: Oct. 27, 2007

(30) Foreign Application Priority Data
Oct. 27, 2006 (KR) 10-2006-0104763

(51) Int. Cl. G06F 3/038; G09G 3/36

(52) U.S. Cl. 345/204; 345/87

(57) ABSTRACT

A liquid crystal display device and a method of driving the same include a display panel which has a first and a second surface facing each other, a plurality of first pixels which display an image on the first surface and a plurality of second pixels which display an image on the second surface, a data driver which supplies first and second data signals to the first pixels and the second pixels, respectively, and a gate driver which supplies gate signals to the first and second pixels. The gate driver and the data driver supply the gate signals and the first data signal to the plurality of first pixels in a first period, and supply the gate signals and the second data signal to the plurality of second pixels in a second period.

This application claims priority to Korean Patent Application No. 10-2006-0104763 filed on Oct. 27, 2006, and all the benefits accruing therefrom under 35 U.S.C. § 119, the contents of which in its entirety are herein incorporated by reference.

### BACKGROUND OF THE INVENTION

(a) Field of the Invention

The present invention relates to a liquid crystal display device and a method of driving the same. More particularly, the present invention relates to a liquid crystal display device and a method of driving the same having an advantage of reduced power consumption while displaying different images on first and second surfaces of the device.

(b) Description of the Related Art

In general, a liquid crystal display (“LCD”) includes a liquid crystal panel assembly having two display panels on which field generating electrodes, such as pixel electrodes and a common electrode, are formed, and a liquid crystal layer interposed therebetween. In the LCD, a voltage is applied to the field generating electrodes which generates an electric field in the liquid crystal layer. The electric field aligns liquid crystal molecules in the liquid crystal layer, and the polarization of incident light is controlled, displaying a desired image.

The LCD is a passive display device which does not emit light by itself. Therefore, one type of LCD, referred to as a transmissive LCD, uses a backlight unit, which transmits light through the liquid crystal layer. Alternatively, light from the outside, such as natural light, is transmitted through the liquid crystal layer, is reflected, and is transmitted back through the liquid crystal layer (referred to as a reflective LCD). Another type of LCD has been developed, known as a transflective or reflective-transmissive LCD (hereinafter referred to simply as a transflective LCD), which uses either a backlight unit or light from the outside, depending upon an operating environment. Both the reflective and the transflective types of LCD are used mainly for small and medium display devices.

In the transflective LCD, each pixel contains a transparent electrode and a reflective electrode electrically connected to each other. Light from the backlight unit is transmitted through the transparent electrode and is then used for display. In addition, outside light from a side opposite the backlight unit is reflected by the reflective electrode and is then used for display.

An LCD of a mobile phone (or other similar device) often displays a complex main image on a first surface of the device, while a relatively simpler image, such as a clock, is displayed on a second surface. To display images on first and second surfaces in such a manner, two liquid crystal panel assemblies overlap each other, and outer surfaces of the liquid crystal panel assemblies are used for the display. However, when image signals having a large number of bits and a large number of gray voltages are used for both the complex image and the simple image, a large driving circuit is required, and power consumption is high.

Therefore, there is a need to provide an LCD device, and a method of driving the same, with an advantage of reduced power consumption while displaying stable images on the first and second surfaces of the device.

### BRIEF SUMMARY OF THE INVENTION

The present invention has been made in an effort to provide an LCD device, and a method of driving the same, with an advantage of reduced power consumption while displaying stable images on the first and second surfaces of the device.

One exemplary embodiment of the present invention provides an LCD which includes a display panel which has first and second surfaces facing each other, a plurality of first pixels which display an image on the first surface, a plurality of second pixels which display an image on the second surface, a data driver which supplies a first and a second data signal to the first pixels and the second pixels, respectively, and a gate driver which has a first and a second gate driving circuit which supplies a gate signal to the first and second pixels. The gate driver and the data driver supply the gate signal and the first data signal to the plurality of first pixels in a first period, and supply the gate signal and the second data signal to the plurality of second pixels in a second period.

The plurality of first pixels and the plurality of second pixels may be arranged alternately.

The LCD may further include a plurality of first gate lines which are connected to the first pixels and a plurality of second gate lines which are connected to the second pixels. The pluralities of first and second gate lines may be arranged alternately.

The first and the second data signals contain a number of values, and the number of values contained in the first data signal may be different from the number of values contained in the second data signal.

At least one of the first and second data signals may have at least two values.

The data driver may include a first data driving circuit which receives a first image signal containing a number of first bits and generates the first data signal, and a second data driving circuit which receives a second image signal containing a number of second bits and generates the second data signal. The number of first bits in the first image signal may be different than the number of second bits in the second image signal.

The first data driving circuit may select one of at least three gray voltages and output the selected gray voltage as the first data signal, and the second data driving circuit may select one of at least two gray voltages and output the selected gray voltage as the second data signal.

The first and second data driving circuits may include output buffers which output the first data signal and the second data signal, respectively.

The gate driver may include a first gate driving circuit which applies a gate-on voltage to the first gate lines in the first period, and a second gate driving circuit which applies the gate-on voltage to the second gate lines in the second period.

The gate driver may include an output terminal which sends a carry signal to an adjacent stage and an output buffer which outputs the gate-on voltages to the first and second gate lines.

The first gate driving circuit and the second gate driving circuit may be located at ends opposite to the first and second gate lines, respectively.

A blanking period is provided between the first period and the second period.

The blanking period may be at least two or more horizontal periods.

The plurality of first pixels may include transmissive pixel electrodes and the plurality of second pixels may include reflective pixel electrodes.

In another exemplary embodiment of the present invention, a method of driving the LCD is provided, the method including sequentially supplying the gate-on voltage to the plurality of first pixels, supplying the first data signal to the plurality of first pixels so as to display an image on the first surface of the display panel, supplying the gate-on voltage to the plurality of second pixels, and supplying the second data signal to the plurality of second pixels so as to display an image on the second surface of the display panel. The first pixels and the second pixels may be alternately disposed.

The method further includes a blanking period before supplying the gate-on voltage to the second pixels.

The blanking period may be at least twice as long as one duration of the gate-on voltage.

The first data driving circuit may select a gray voltage corresponding to the first image signal from among at least three gray voltages, and apply the selected gray voltage to the plurality of first pixels as the first data signal. The second data driving circuit may select a gray voltage corresponding to the second image signal from among at least two gray voltages, and apply the selected gray voltage to the plurality of second pixels as the second data signal.

The plurality of first pixels may be transmissive pixels which transmit incident light, and the plurality of second pixels may be reflective pixels which reflect incident light.

### BRIEF DESCRIPTION OF THE DRAWINGS

The present invention will become more apparent by describing exemplary embodiments thereof in more detail with reference to the accompanying drawings, in which:

FIG. 1 is a block diagram of an LCD according to one exemplary embodiment of the present invention;

FIG. 2 is an equivalent circuit diagram of one pair of pixels in the LCD according to one exemplary embodiment of the present invention;

FIG. 3 is a plan view layout of a liquid crystal panel assembly according to one exemplary embodiment of the present invention;

FIG. 4 is a cross-sectional view of the liquid crystal panel assembly of FIG. 3 taken along line IV-IV;

FIG. 5 is a cross-sectional view of the liquid crystal panel assembly of FIG. 3 taken along line V-V;

FIG. 6 is a block diagram of a data driver according to one exemplary embodiment of the present invention;

FIG. 7 is a block diagram of a gate driver according to one exemplary embodiment of the present invention; and

FIG. 8 is a signal waveform timing chart showing operation of one exemplary embodiment of the present invention.

### DETAILED DESCRIPTION OF THE INVENTION

The invention now will be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, a liquid crystal display device according to one exemplary embodiment of the present invention will be described in further detail with reference to the accompanying drawings.

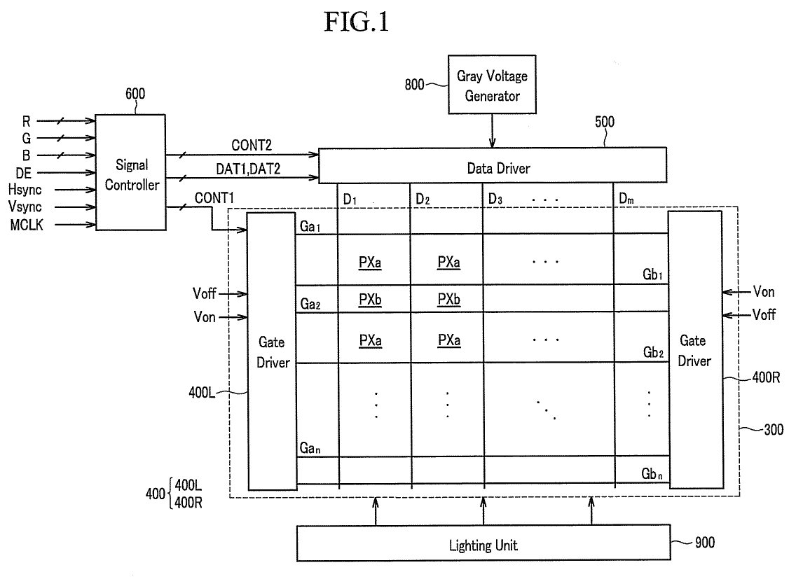

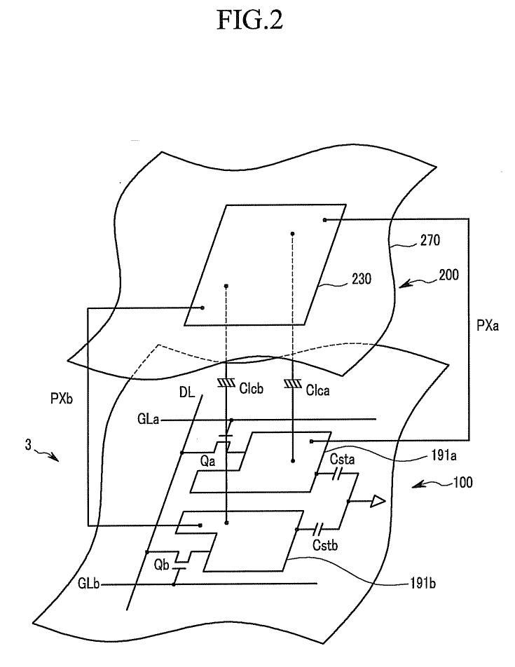

FIG. 1 is a block diagram of an LCD according to one exemplary embodiment of the present invention. FIG. 2 is an equivalent circuit diagram of one pair of pixels in the LCD according to one exemplary embodiment of the present invention.

Referring to FIG. 1, an LCD according to one exemplary embodiment of the present invention includes a liquid crystal panel assembly 300, a gate driver 400, a data driver 500, a gray voltage generator 800, a lighting unit 900 and a signal controller 600.

Further referring to FIG. 1, the liquid crystal panel assembly 300 includes a plurality of signal lines Ga₁ to Gaₙ, Gb₁ to Gbₙ and D₁ to Dₘ, and a plurality of pairs of first and second pixels PXa and PXb which are connected to the signal lines Ga₁ to Gaₙ, Gb₁ to Gbₙ and D₁ to Dₘ and are substantially arranged in a matrix shape.

Referring to FIGS. 1 and 2, the signal lines Ga₁ to Gaₙ, Gb₁ to Gbₙ and D₁ to Dₘ are provided on the lower display panel 100, and include a plurality of pairs of first and second gate lines Ga₁ to Gaₙ and Gb₁ to Gbₙ which transmit gate signals (also referred to as “scanning signals”) and a plurality of data lines D₁ to Dₘ which transmit data voltages. The gate lines Ga₁ to Gaₙ and Gb₁ to Gbₙ extend in a row direction substantially parallel with one another, and the data lines D₁ to Dₘ extend in a column direction substantially parallel with one another.

In view an equivalent circuit diagram of a pair of first and second pixels PXa and PXb shown in FIG. 2, the liquid crystal panel assembly 300 (not fully shown in FIG. 2) includes lower and upper display panels 100 and 200, respectively which face each other and a liquid crystal layer 3 which is interposed therebetween.

The first pixels PXa and the second pixels PXb display images on separate surfaces of the liquid crystal panel assembly 300. For example, when the first pixels PXa display an image on a rear surface of the liquid crystal panel assembly 300, the second pixels PXb display an image on a front surface thereof. Alternatively, the first pixels PXa and the second pixels PXb may display images on the front and rear surfaces, respectively, of the liquid crystal panel assembly 300.

The first and second pixels PXa and PXb are connected to signal lines. Specifically, first and second pixels PXa and PXb are connected to gate lines GLa and GLb, respectively, and are simultaneously connected to a data line DL. Each pixel PXa/PXb includes a corresponding switching element Qa/Qb which is connected to the signal lines GLa/GLb and DL, and a liquid crystal capacitor Clca/Clcb and a storage capacitor Csta/Cstb which are connected to the switching element Qa/Qb.

The switching element Qa/Qb is a three terminal element, such as a thin film transistor (“TFT”) provided in the lower display panel 100. A control terminal of the switching element Qa/Qb is connected to the gate line GLa/GLb, an input terminal thereof is connected to the data line DL, and an output terminal is connected to the liquid crystal capacitor Clca/Clcb and the storage capacitor Csta/Cstb.

The liquid crystal capacitor Clca/Clcb has a first/second pixel electrode 191a/191b of the lower display panel 100 and a common electrode 270 of the upper display panel 200 as terminals, and the liquid crystal layer 3 between the two electrodes 191a/191b and 270 functions as a dielectric material. The pixel electrode 191a/191b is connected to the switching element Qa/Qb, and the common electrode 270 is formed on the entire surface of the upper display panel 200. A common voltage Vcom is applied to the common electrode 270. Unlike that as illustrated in FIG. 2, the common electrode 270 may be provided on the lower display panel 100; in this arrangement, at least one of the pixel electrode 191a/191b and the common electrode 270 may be formed in a linear shape or a bar shape. One of the pixel electrodes 191a and 191b may be a transmissive electrode and the other may be a reflective electrode. For example, the first pixel electrode 191a may be a transparent transmissive electrode and the second pixel electrode 191b may be a reflective electrode.

The storage capacitor Csta/Cstb, which assists the liquid crystal capacitor Clca/Clcb, includes a separate signal line (not shown) provided in the lower display panel 100 and the pixel electrodes 191a and 191b are provided to overlap each other with an insulator interposed therebetween. A fixed voltage, such as the common voltage Vcom, is applied to the separate signal line.

In order to display color, the pair of pixels PXa and PXb uniquely displays one of the primary colors (e.g., one of red, green or blue) (spatial division) or the pair of pixels PXa and PXb alternately displays the primary colors over time (temporal division). As a result, the primary colors are spatially or temporally synthesized and a desired specific color is displayed. In FIG. 2, which illustrates an example of spatial division, the pair of pixels PXa and PXb has a color filter 230 which represents one of the primary colors in a region of the upper display panel 200 corresponding to the pixel electrodes 191a and 191b. The color filter 230 may be provided above or below the pixel electrodes 191a and 191b of the lower display panel 100.

In the liquid crystal panel assembly 300, at least one polarizer (not shown) is provided.

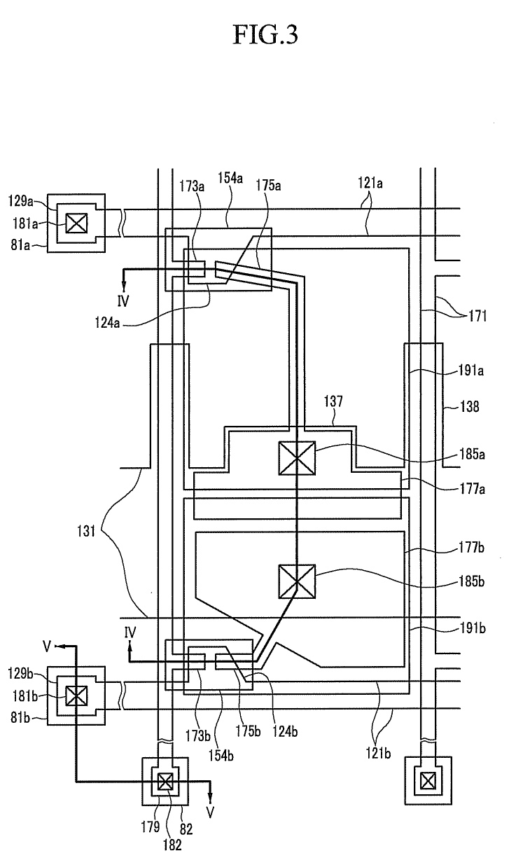

Hereinafter, the structure of the liquid crystal panel assembly 300 according to one exemplary embodiment of the present invention will be described in further detail with reference to FIGS. 3, 4 and 5.

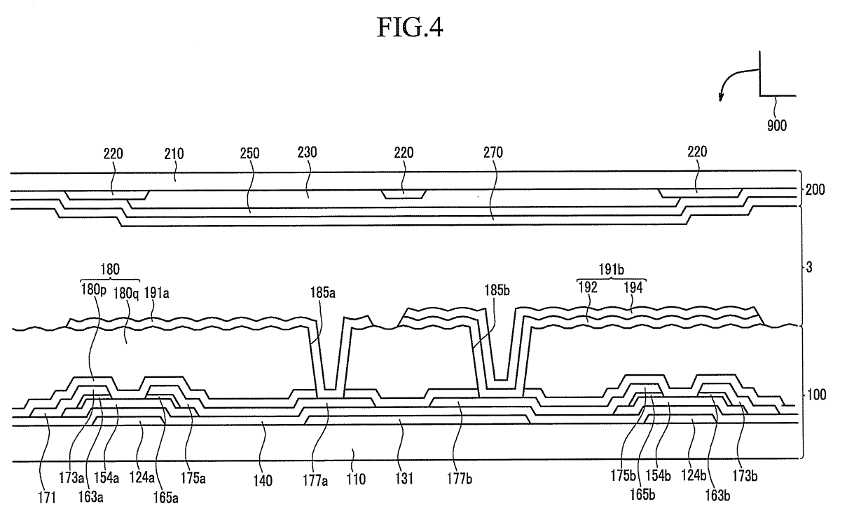

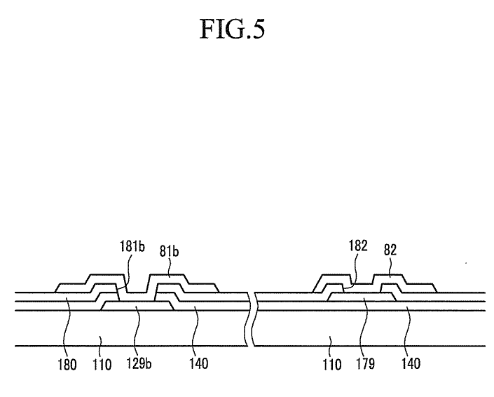

FIG. 3 is a plan view layout of the liquid crystal panel assembly according to one exemplary embodiment of the present invention, FIG. 4 is a cross-sectional view of the liquid crystal panel assembly of FIG. 3 taken along line IV-IV, and FIG. 5 is a cross-sectional view of the liquid crystal panel assembly of FIG. 3 taken along line V-V.

The liquid crystal panel assembly 300, according to one exemplary embodiment of the present invention, includes a TFT array panel 100 and a common electrode panel 200 which face each other, and a liquid crystal layer 3 which is interposed between the two display panels 100 and 200.

Hereinafter, the TFT array panel 100 will be described in further detail with reference to the accompanying drawings.

A plurality of pairs of first and second gate lines 121a and 121b and a plurality of storage electrode lines 131 are formed on an insulation substrate 110 made of transparent glass or plastic, for example, but is not limited thereto.

The first and second gate lines 121a and 121b substantially extend in a horizontal direction, as illustrated in FIG. 3, and are alternately arranged. The first gate line 121a includes a plurality of first gate electrodes 124a which protrude downward and a wide end portion 129a which connects to a different layer or an external driving circuit (not shown). The second gate line 121b is disposed below the first gate line 121a. The second gate line 121b includes a plurality of second gate electrodes 124b which protrude upward, and a wide end portion 129b which connects to a different layer or an external driving circuit (not shown). A gate driving circuit (not shown) which generates gate signals may be mounted on a flexible printed circuit film (not shown) which is attached to the substrate 110, may be mounted directly on the substrate 110, or may be integrated into the substrate 110. When the gate driving circuit is integrated into the substrate 110, the gate lines 121a and 121b may extend to be connected directly to the gate driving circuit.

The storage electrode lines 131, which are supplied with a predetermined voltage, extend in a direction substantially parallel with the gate lines 121a and 121b. Each of the storage electrode lines 131 is disposed between a particular first gate line 121a and a particular second gate line 121b, and is closer to the particular second gate line 121b, which is disposed on the lower side, than to the particular first gate line 121a. The storage electrode line 131 has a plurality of protrusions 137 and 138 which have a width larger than the gate lines 121a and 121b, protrude upward, and are alternately arranged. However, the shape and arrangement of the storage electrode line 131 may be modified in various ways.

The gate lines 121a and 121b and the storage electrode line 131 may be made of, for example, an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), titanium (Ti) or other similar metals and/or alloys. The gate lines 121a and 121b and the storage electrode line 131 may have a multi-layered structure including two conductive layers (not shown) whose physical properties are different from each other. Of these conductive layers, one conductive layer is made of a metal having low resistivity, such as an aluminum-based metal, a silver-based metal, or a copper-based metal in order to reduce signal delay or voltage drop. In contrast, the other conductive layer is made of a different material, particularly a material having excellent physical, chemical and electrical contact characteristics to indium tin oxide (“ITO”) and indium zinc oxide (“IZO”), such as, but not limited to, a molybdenum-based metal, chromium, titanium or tantalum. Specific examples of the combination include, but are not limited to, a combination of a chromium lower layer and an aluminum (alloy) upper layer, and a combination of an aluminum (alloy) lower layer and a molybdenum (alloy) upper layer. Alternatively, the gate lines 121a and 121b and the storage electrode line 131 may be made of various metals or conductors other than the materials described above.

In exemplary embodiment, a side surface of each of the gate lines 121a and 121b and the storage electrode line 131 is inclined with respect to a surface of the substrate 110, and the inclination angle is in a range of about 30° to about 80°.

A gate insulating layer 140 made of silicon nitride (“SiNₓ”) or silicon oxide (“SiOₓ”) is formed on the gate lines 121a and 121b and the storage electrode lines 131.

A plurality of first and second semiconductor islands 154a and 154b made of hydrogenated amorphous silicon (“a-Si”) or polycrystalline silicon (“poly-Si” or “p-Si”) are formed on the gate insulating layer 140. The semiconductor islands 154a and 154b are disposed on the gate electrodes 124a and 124b, respectively.

A plurality of pairs of first ohmic contact islands 163a and 165a are formed on the first semiconductor island 154a and a plurality of second ohmic contact islands 163b and 165b are formed on the second semiconductor island 154b. The ohmic contacts 163a, 163b, 165a and 165b may be made of a material such as n+ a-Si doped with a high concentration of an n-type impurity such as phosphorus, or of a silicide.

In exemplary embodiments, a side surface of each of the semiconductor islands 154a and 154b and the ohmic contacts 163a, 163b, 165a and 165b is inclined with respect to a surface of the substrate 110 at an inclination angle in a range of about 30° to about 80°.

A plurality of data lines 171 and a plurality of first and second drain electrodes 175a and 175b are formed on the ohmic contacts 163a, 163b, 165a and 165b and the gate insulating layer 140.

The data lines 171 transmit data signals and substantially extend in a vertical direction to cross the gate lines 121a and 121b and the storage electrode lines 131, as illustrated. Each of the data lines 171 includes a plurality of first and second source electrodes 173a and 173b which extend toward the gate electrodes 124a and 124b, and a wide end portion 179 which connects to a different layer or an external driving circuit (not shown). A data driving circuit (not shown) which generates data signals may be mounted on a flexible printed circuit film (not shown) which is attached to the substrate 110, may be directly mounted on the substrate 110, or may be integrated into the substrate 110. When the data driving circuit is integrated into the substrate 110, the data lines 171 may extend to be connected directly to the data driving circuit.

The first and second drain electrodes 175a and 175b are separated from the data line 171 and face the first and second source electrodes 173a and 173b with the first and second gate electrodes 124a and 124b as a center, respectively. Each of the drain electrodes 175a and 175b include one end portion having a wide extension 177a and 177b, respectively, and the other end portion having a bar shape, as illustrated in FIG. 3. The wide extensions 177a and 177b overlap the storage electrode line 131 and the bar end portions face the source electrodes 173a and 173b, respectively.

One gate electrode 124a/124b, one source electrode 173a/173b and one drain electrode 175a/175b form one TFT together with the semiconductor island 154a/154b. A channel of the TFT is formed in the semiconductor island 154a/154b between the source electrode 173a/173b and the drain electrode 175a/175b.

In exemplary embodiments, the data lines 171 and the drain electrodes 175a and 175b are made of a refractory metal such as molybdenum, chromium, tantalum, or titanium or an alloy thereof. The data lines 171 and the drain electrodes 175a and 175b may have a multi-layered structure having a refractory metal layer (not shown) and a low-resistance conductive layer (not shown). Examples of the multi-layered structure include, but are not limited to, a two-layered structure of a chromium or molybdenum (alloy) lower layer and an aluminum (alloy) upper layer, and a three-layered structure of a molybdenum (alloy) lower layer, an aluminum (alloy) intermediate layer, and a molybdenum (alloy) upper layer. However, the data lines 171 and the drain electrodes 175a and 175b may be made of various metals or conductors other than the above materials.

In exemplary embodiments, a side surface of each of the data lines 171 and the drain electrodes 175a and 175b is inclined with respect to a surface of the substrate 110 at an inclination angle which is in a range of about 30° to about 80°

The ohmic contacts 163a, 163b, 165a and 165b are interposed only between the underlying semiconductor islands 154a and 154b and the overlying data line 171 and drain electrodes 175a and 175b to reduce the contact resistance therebetween. The semiconductor islands 154a/154b have exposed portions which are not covered with the data line 171 and the drain electrodes 175a and 175b, including a portion between the source electrodes 173a/173b and the drain electrodes 175a/175b.

A passivation layer 180 is formed on the data lines 171, the drain electrodes 175a and 175b, and the exposed portions of the semiconductor islands 154a and 154b. The passivation layer 180 includes a lower layer 180p made of an inorganic insulator, such as SiNₓ or SiOₓ, and an upper layer 180q made of an organic insulator. In an exemplary embodiment, the upper passivation layer 180q has a dielectric constant of 4.0 or less and may be photosensitive. Protrusions and depressions are formed on a surface of the upper passivation layer 180q. However, the passivation layer 180 may be a single-layered structure made of an inorganic insulator or an organic insulator.

A plurality of contact holes 182 which expose the end portions 179 of the data lines 171, and a plurality of contact holes 185a and 185b which expose the extensions 177a and 177b of the first and second drain electrodes 175a and 175b are formed in the passivation layer 180. Further, a plurality of contact holes 181a and 181b which expose the wide end portions 129a and 129b of the gate lines 121a and 121b are formed in the passivation layer 180 and the gate insulating layer 140.

A plurality of pairs of first and second pixel electrodes 191a and 191b and a plurality of contact assistants 81a, 81b and 82 are formed on the passivation layer 180.

The first pixel electrode 191a and the second pixel electrode 191b are bent according to the protrusions and depressions of the passivation layer 180 and are separated from each other. The second pixel electrode 191b includes a transparent electrode 192 and a reflective electrode 194 above the transparent electrode 192. The transparent electrode 192 may be omitted.

The first pixel electrode 191a and the transparent electrode 192 are made of a transparent conductive material, such as ITO or IZO, and the reflective electrode 194 is made of a reflective metal such as aluminum, silver, chromium or an alloy thereof. However, the reflective electrode 194 may have a dual-layered structure of a low-resistance reflective upper layer (not shown) made of aluminum, silver or an alloy thereof, and a lower layer (not shown) made of a molybdenum-based metal, chromium, tantalum, or titanium, which has good electrical contact characteristics with other metals such as ITO or IZO.

The first pixel electrode 191a is physically and electrically connected to the first drain electrode 175a (via the first drain electrode extension 177a) through the contact hole 185a and is supplied with a data voltage from the first drain electrode 175a. The second pixel electrode 191b is physically and electrically connected to the second drain electrode 175b (via the second drain electrode extension 177b) through the contact hole 185b and is supplied with the data voltage from the second drain electrode 175b.

The data voltage applied to the first/second pixel electrode 191a/191b and a common voltage applied to a common electrode 270 of the common electrode panel 200 generates an electric field in a liquid crystal layer 3 (FIG. 4). The electric field determines the alignment of liquid crystal molecules of the liquid crystal layer 3 between the two electrodes 191a/191b and 270, and polarization of light which passes through the liquid crystal layer 3 is controlled thereby. The first/second pixel electrode 191a/191b and the common electrode 270 form a liquid crystal capacitor Clca/Clcb which maintains the applied voltage after the TFT is turned off.

The transflective liquid crystal panel assembly 300 includes the TFT array panel 100, the common electrode panel 200 and the liquid crystal layer 3, and may be divided into a transmissive region and a reflective region which may be defined by the first pixel electrode 191a and the second pixel electrode 191b, respectively.

To display images using the transmissive region, incident light from a first surface of the liquid crystal panel assembly 300, that is, the common electrode panel 200, passes through the liquid crystal layer 3 and is emitted from a second surface of the liquid crystal panel assembly 300, that is, the TFT array panel 100. To display images using the reflective region, incident light from the first surface passes through the liquid crystal layer 3, is reflected by the second pixel electrode 191b which is bent to improve light reflection efficiency, passes back through the liquid crystal layer 3 again, and is emitted from the first surface.

The first/second pixel electrode 191a/191b and the extension 177a/177b of the first/second drain electrode 175a/175b connected to the first/second pixel electrode 191a/191b overlap the protrusion 137 and the storage electrode line 131 and form a storage capacitor Csta/Cstb which improves voltage maintaining capability of the liquid crystal capacitor Clca/Clcb. In addition, a portion of the storage electrode line 131 overlaps the extension 177a of the first drain electrode 175a and another portion overlaps the extension 177b of the second drain electrode 175b. Therefore, the storage capacitor Csta/Cstb of the two pixels PXa/PXb is formed using one storage electrode line 131 to secure transmittance from the two pixels PXa and PXb.

The contact assistants 81a, 81b and 82 are connected to the end portions 129a and 129b of the gate lines 121a and 121b and the end portions 179 of the data lines 171 through the contact holes 181a, 181b and 182. The contact assistants 81a, 81b and 82 complement adhesion of the end portions 129a and 129b of the gate lines 121a and 121b and the end portions 179 of the data lines 171 to another device, and protect the end portions 129a, 129b and 179.

Hereinafter, the common electrode panel 200 will be described in further detail with reference to the accompanying drawings.

Referring to FIG. 4, a light blocking member 220 is formed on an insulation substrate 210 made of transparent glass or plastic. The light blocking member 220 is referred to as a black matrix. The light blocking member 220 defines a plurality of openings which face the first pixel electrodes 191a and the second pixel electrodes 191b and reduces or effectively prevents or reduces light leakage between the first pixel electrodes 191a and the second pixel electrodes 191b.

A plurality of color filters 230 is formed on the substrate 210. The color filters 230 are disposed to be substantially accommodated in the openings surrounded by the light blocking member 220. The color filters 230 may extend in a vertical direction along the first pixel electrode 191a and the second pixel electrode 191b and may have a stripe shape. Each of the color filters 230 may display one of the primary colors (e.g., one of red, green or blue).

An overcoat 250 is formed on the color filters 230 and the light blocking member 220. The overcoat 250 may be made of an organic insulator. The overcoat 250 protects the color filters 230, effectively prevents or reduces the color filters 230 from being exposed, and provides a planarized surface. However, the overcoat 250 may be omitted in alternative exemplary embodiments.

The common electrode 270 is formed on the overcoat 250. In exemplary embodiments, the common electrode 270 is made of a transparent conductor such as ITO or IZO.

An alignment layer (not shown), which aligns the liquid crystal layer 3, is coated on inner surfaces of the display panel 100 and 200. Further, at least one polarizer (not shown) is provided on inner or outer surfaces of the display panels 100 and 200.

The liquid crystal layer 3 may be aligned vertically or horizontally.

The liquid crystal panel assembly 300 further includes a plurality of elastic spacers (not shown) which support the TFT array panel 100 and the common electrode panel 200 to form a gap therebetween.

The liquid crystal panel assembly 300 may further include a sealant (not shown) which bonds the TFT array panel 100 and the common electrode panel 200 to each other. The sealant is disposed at an edge of the common electrode panel 200.

As shown in FIG. 4, the lighting unit 900 is disposed to be closer to the common electrode panel 200 than to the TFT array panel 100 of the liquid crystal panel assembly 300 and irradiates light in a direction substantially from the common electrode panel 200 toward the TFT array panel 100. The lighting unit 900 may include a light source (not shown) which generates light, a light guide (not shown) which guides and diffuses light generated by the light source toward the liquid crystal panel assembly 300, and optical sheets (not shown). The light guide may have a shape similar to the common electrode panel 200 and the optical sheets may be disposed between the light guide and the common electrode panel 200. A fluorescent lamp, a light emitting diode (“LED”), or other similar device may be used as the light source. The light source may be disposed on a side of the light guide.

The operation of the LCD according to one exemplary embodiment of the present invention will be described more fully hereinafter with reference to the accompanying drawings.

Returning to FIG. 1, the gray voltage generator 800 generates two sets of gray voltages (hereinafter referred to as a set of reference gray voltages) relative to a desired transmittance of the pixels PXa and PXb. One of the two sets of gray voltages has a positive value with respect to the common voltage Vcom and the other set has a negative value with respect to the common voltage Vcom.

The data driver 500 is connected to the data lines D₁ to Dₘ of the liquid crystal panel assembly 300, generates data voltages and applies the generated data voltages to the data lines D₁ to Dₘ.

The gate driver 400 includes first and second gate driving circuits 400L and 400R. Each of the gate driving circuits 400L and 400R is connected to the gate lines Ga₁ to Gaₙ or Gb₁ to Gbₙ of the liquid crystal panel assembly 300 and applies gate signals obtained by combining a gate-on voltage Von and a gate-off voltage Voff to the gate lines Ga₁ to Gaₙ or Gb₁ to Gbₙ.

The first gate driving circuit 400L is disposed at a left edge of the liquid crystal panel assembly 300 and applies the gate signals to first gate lines Ga₁ to Gaₙ. The second gate driving circuit 400R is disposed at a right edge of the liquid crystal panel assembly 300 and applies the gate signals to second gate lines Gb₁ to Gbₙ. Each of the first gate driving circuit 400L and the second gate driving circuit 400R starts to apply the gate-on voltage Von from the uppermost gate line Ga₁/Gb₁ of the liquid crystal panel assembly 300. After one gate driving circuit 400L/400R supplies the gate-on voltage Von to the last gate line Gaₙ/Gbₙ the other gate driving circuit 400R/400L starts to apply the gate-on voltage Von to the uppermost gate line Gb₁/Ga₁.

The signal controller 600 controls the gate driver 400 and data driver 500.

The gate driver 400, the data driver 500, the signal controller 600 and the gray voltage generator 800 are collectively referred to hereinafter as the driving devices 400, 500, 600 and 800.

The driving devices 400, 500, 600 and 800 may be directly mounted on the liquid crystal panel assembly 300 as at least one IC chip (not shown), or may be mounted on a flexible printed circuit film (not shown) and attached to the liquid crystal panel assembly 300 as a tape carrier package (“TCP”) (not shown). Further, each driving device may be mounted on a separate printed circuit board (“PCB”) (not shown). Alternatively, the driving devices 400, 500, 600 and 800 may be integrated into the liquid crystal panel assembly 300, together with the signal lines Ga₁ to Gaₙ, Gb₁ to Gbₙ and D₁ to Dₘ and the TFT switching elements Qa and Qb (not shown). In addition, the driving devices 400, 500, 600 and 800 may be integrated into a single chip (not shown). In this case, at least one of the driving devices 400, 500, 600 and 800 or at least one circuit element thereof may be provided outside the single chip.

The signal controller 600 receives input image signals R, G and B and an input control signal which control operation thereof from a graphics controller (not shown). The input image signals R, G and B have luminance information for each pixel PXa/PXb, and the luminance information contains a predetermined number of gray levels, for example 1024 (=2¹⁰), 256 (=2⁸) or 64 (=2⁶). The input control signal includes a vertical synchronizing signal Vsync, a horizontal synchronizing signal Hsync, a main clock signal MCLK and a data enable signal DE.

The signal controller 600 processes the input image signals R, G and B based upon the input control signal in accordance with a desired operation condition of the liquid crystal panel assembly 300, and generates a gate control signal CONT1, a data control signal CONT2, and digital image signals DAT1 and DAT2. The signal controller 600 transmits the gate control signal CONT1 to the gate driver 400 and transmits the data control signal CONT2 and the digital image signals DAT1 and DAT2 to the data driver 500.

The gate control signal CONT1 includes scanning start signals LSTV and RSTV which instruct the gate driver 400 to start scanning and at least one clock signal which controls an output cycle of the gate-on voltage Von. The gate control signal CONT1 may further include an output enable signal OE (not shown) which defines the duration of the gate-on voltage Von.

The data control signal CONT2 includes a horizontal synchronization start signal STH (not shown) which indicates start of transmission of the digital image signals DAT1 and DAT2, a load signal LOAD (not shown) which instructs the data driver 500 to apply analog data voltages which correspond to the digital image signals DAT1 and DAT2 to the data lines D₁ to Dₘ, and a data clock signal HCLK. The data control signal CONT2 may further include an inversion signal RVS (not shown) which inverts the voltage polarity of the analog data voltage with respect to the common voltage Vcom (hereinafter, “the polarity of the data voltage with respect to the common voltage” is simply referred to as “the polarity of the data voltage”).

The data driver 500 receives the digital image signals DAT1 and DAT2 which correspond to a row of pixels PXa and PXb, respectively, according to the data control signal CONT2 from the signal controller 600, and selects the gray voltages corresponding to the digital image signals DAT1 and DAT2. The data driver 500 converts the digital image signals DAT1 and DAT2 into a general data voltage Vdat1 and a simple data voltage Vdat2, respectively, and applies the general and simple data voltages Vdat1 and Vdat2 to the data lines D₁ to Dₘ.

The gate driver 400 applies the gate-on voltage Von to the gate lines Ga₁ to Gaₙ and Gb₁ to Gbₙ according to the gate control signal CONT1 from the signal controller 600 and turns on the switching elements Qa and Qb which are connected to the gate lines Ga₁ to Gaₙ and Gb₁ to Gbₙ, respectively. Therefore, the general and simple data voltages Vdat1 and Vdat2 applied to the data lines D₁ to Dₘ are applied to the pixels PXa and PXb through the turned-on switching elements Qa and Qb.

A difference between the data voltage Vdat1 and Vdat2 applied to the pixels PXa and PXb and the common voltage Vcom is a charging voltage, e.g., a pixel voltage, of the liquid crystal capacitor Clca and Clcb. The magnitude of the pixel voltage determines the arrangement of liquid crystal molecules which changes polarization of light passing through the liquid crystal layer 3. The change of the polarization causes a change in transmittance of light by the polarizer. Therefore, the pixels PXa and PXb display a desired luminance according to the gray levels of the digital image signals DAT1 and DAT2, respectively.

This process is repeated for every one horizontal period (“1H”), which is equal to one cycle of the horizontal synchronizing signal Hsync and one cycle of the data enable signal DE. To display images on the first and second surfaces of the liquid crystal panel assembly 300, the gate-on voltage Von is sequentially applied to all the first gate lines Ga₁ to Gaₙ and the general data voltages Vdat1 are applied to all of the first pixels PXa, such that the image for one frame is displayed on the first surface of the liquid crystal panel assembly 300. The gate-on voltage Von is then sequentially applied to all the second gate lines Gb₁ to Gbₙ and the simple data voltage Vdat2 s are applied to all of the second pixels PXb, such that the image for one frame is displayed on the second surface of the liquid crystal panel assembly 300.

After one frame is completed, the state of the inversion signal RVS (not shown) applied to the data driver 500 is controlled such that the polarity of the data voltage applied to each pixel PXa/PXb is inverted with respect to the polarity of the previous frame (“frame inversion.”) Therefore, in one frame, the polarity of the data voltage which flows in a data line may be inverted (for example, row inversion and dot inversion) or the polarities of the data voltages which are applied to a row of pixels may vary (for example, column inversion and dot inversion), according to characteristics of the inversion signal RVS (not shown).

When images are displayed on the first surface and the second surface of the liquid crystal panel assembly 300, a complex image, such as would be associated with operating a cellular telephone, playing a video game, or operating a camera, may be displayed on the first surface, while a relatively simpler image, such as a clock display or an operating manual for a device, may be displayed on the second surface. In such a case, a general digital image signal DAT1 (hereinafter DAT1 is referred to as the general digital image signal) representing a complex image would have a large number of gray levels and a simple digital image signal DAT2 (hereinafter DAT2 is referred to as the simple digital image signal) representing a simple image would have a small number of gray levels. Accordingly, the general digital image signal DAT1 representing a complex image would have a large number of bits and the simple digital image signal DAT2 representing a simple image would have a small number of bits.

Hereinafter, an example of the data driver 500 according to one exemplary embodiment of the present invention will be described in further detail with reference to the accompanying drawings.

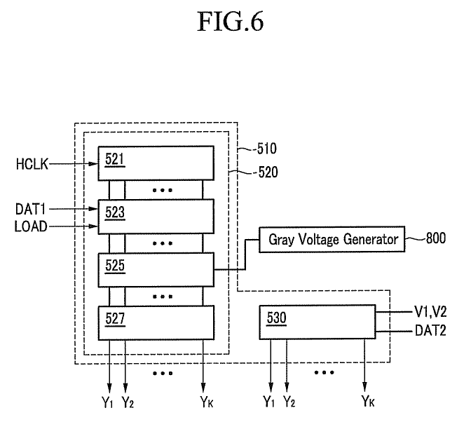

FIG. 6 is a block diagram of the data driver 500 according to one exemplary embodiment of the present invention. Referring to FIG. 6, the data driver 500 may include at least one data driving chip 510.

The data driving chip 510 includes a general data driving circuit 520 which generates a general data voltage Vdat1 which corresponds to a complex image and a simple data driving circuit 530 which generates a simple data voltage Vdat2 corresponding to a simple image. Hereinafter, the general data voltage Vdat1 and the simple data voltage Vdat2 are collectively referred to as Vout. The simple data voltage Vdat2 may have a small number of values, for example, two values, and the general data voltage Vdat1 may have a larger number of values than the simple data voltage Vdat2.

The general data driving circuit 520 includes a shift register 521, a latch 523, a digital-to-analog converter 525 and an output buffer 527 which are sequentially connected.

When the horizontal synchronization start signal STH (not shown) (or shift clock signal) (not shown) is input to the shift register 521, the shift register 521 transmits the general digital image signal DAT1 to the latch 523 according to the data clock signal HCLK.

The latch 523 stores the general digital image signal DAT1 and sends the general digital image signal DAT1 to the digital-to-analog converter 525 according to the load signal LOAD.

The digital-to-analog converter 525 receives the gray voltage from the gray voltage generator 800, converts the digital general digital image signal DAT1 into the analog general data voltage Vdat1 and sends the converted general data voltage Vdat1 to the output buffer 527.

The output buffer 527 sends the general data voltage Vdat1 from the digital-to-analog converter 525 to a corresponding one of the data lines D₁ to Dₘ and retains the general data voltage Vdat1 for one horizontal period 1H. In FIG. 6, the general data voltage Vdat1 is represented as outputs Y₁ to Yₖ from the output buffer 527.

The simple data driving circuit 530 receives a first voltage V1 and a second voltage V2, selects one of the first and second voltages V1 and V2 according to the simple digital image signal DAT2 and outputs the selected voltage as the simple data voltage Vdat2. In FIG. 6, the simple data voltage Vdat2 is represented as outputs Y₁ to Yₖ from the simple data driving circuit 530.

The simple data driving circuit 530 further includes an output buffer (not shown) which outputs the simple data voltage Vdat2 to a corresponding one of the data lines D₁ to Dₘ and retains the simple data voltage Vdat2 for one horizontal period 1H.

The simple data driving circuit 530 may be implemented by a simple selection circuit, and the size of the circuit is therefore much smaller than the size of the general data driving circuit 520. As a result, the simple data driving circuit 530 provides an advantage of lower power consumption than the general data driving circuit 520, and therefore overall power consumption of the LCD device is effectively reduced according to one exemplary embodiment of the present invention.

Hereinafter, an example of the gate driver 400 according to one exemplary embodiment of the present invention will be described in further detail with reference to the accompanying drawings.

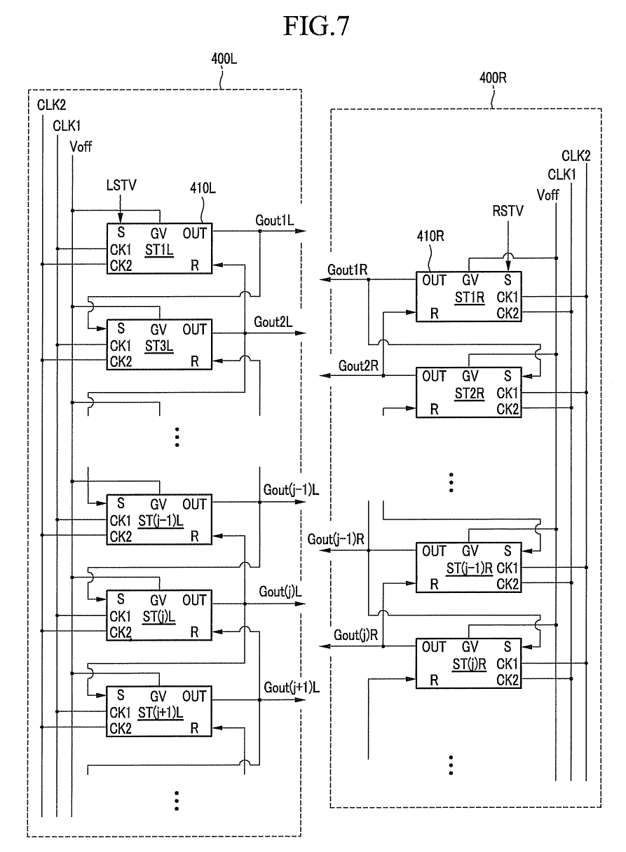

FIG. 7 is a block diagram of a gate driver according to one exemplary embodiment of the present invention. The gate driver 400 shown in FIG. 7 is a shift register which includes a first gate driving circuit 400L disposed on a left side of the liquid crystal panel assembly 300 and a second gate driving circuit 400R disposed on a right side of the liquid crystal panel assembly 300. The gate driving circuit 400L/400R includes a plurality of stages 410L/410R.

Scanning start signals LSTV and RSTV, first and second clock signals CLK1 and CLK2 and the gate-off voltage Voff are input to the gate driver 400. The first clock signal CLK1 and the second clock signal CLK2 may be reversed. A high level voltage of each of the clock signals CLK1 and CLK2 may be consistent with the gate-on voltage Von and a low level voltage thereof may be consistent with the gate-off voltage Voff, such that the switching elements Qa and Qb of the pixels PXa and PXb are driven with the clock signals CLK1 and CLK2, respectively.

Each stage of the plurality of stages 410L and 410R includes a set terminal S, a reset terminal R, a gate voltage terminal GV, an output terminal OUT, and first and second clock terminals CK1 and CK2.

Within the stages 410L of the first gate driving circuit 400L, a gate output of a previous stage ST(j−1)L, that is a previous stage gate output Gout(j−1)L, is input to a set terminal S of the subsequent stage, that is a j-th stage ST(j)L, and a gate output of a next stage ST(j+1)L, that is, a next gate output Gout(j+1)L, is input to the reset terminal R thereof. The first and second clock signals CLK1 and CLK2 are input to the first and second clock terminals CK1 and CK2, respectively, of each stage. A gate output Gout(j)L is sent to the first gate lines Ga₁ to Gaₙ through an output terminal OUT of each respective stage.

In a similar manner, within the stages 410R of the second gate driving circuit 400R, a previous gate output Gout(j−1)R is input to the set terminal S of a j-th stage ST(j)R, and a next gate output Gout(j+1)R is input to the reset terminal R thereof, and the gate output Gout(j)R is sent to the second gate lines Gb₁ to Gbₙ through the output terminal OUT thereof. The first and second clock signals CLK1 and CLK2 are input to the first and second clock terminals CK1 and CK2

The adjacent stages 410L and 410R transmit appropriate gate outputs to the gate lines Ga₁ to Gaₙ and Gb₁ to Gbₙ, respectively. To transmit the appropriate gate outputs to the gate lines, each of the stages 410L and 410R is connected to three of the gate lines Ga₁ to Gaₙ and Gb₁ to Gbₙ, respectively, e.g., Gout(j−1)L, Gout(j)L and Gout(j+1)L are connected to three of the gate lines Ga₁ to Gaₙ and Gout(j−1)R, Gout(j)R and Gout(j+1)R are connected to three of the gate lines Gb₁ to Gbₙ. Therefore, each of the stages 410L and 410R send the gate output to one of the three gate lines (of Ga₁ to Gaₙ and Gb₁ to Gbₙ) and receive the previous gate output and the next gate output through the remaining two gate lines (of Ga₁ to Gaₙ and Gb₁ to Gbₙ).

According to another exemplary embodiment of the present invention, a separate output terminal (not shown) which sends a carry signal (not shown) to be output to the previous and next stages may be provided in each stage. Further, a buffer (not shown) which is connected to the output terminal OUT may be provided.

In summary, the first and second gate driving circuits 400L and 400R are independently driven. The stages 410L and 410R of the gate driving circuits 400L and 400R generate the gate outputs on the basis of the previous gate output and the next gate output in synchronization with the first and second clock signals CLK1 and CLK2, respectively. Finally, the scanning start signals LSTV and RSTV are only input to the first stages ST1L and ST1R, respectively.

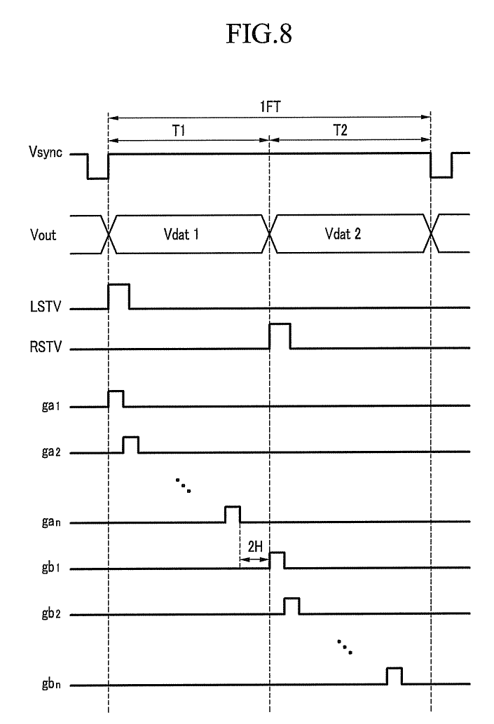

Hereinafter, the operation of the LCD having the data driver of FIG. 6 and the gate driver of FIG. 7 will be described in further detail with reference to FIGS. 6, 7 and 8. FIG. 8 is a signal waveform timing chart showing operation of the LCD according to one exemplary embodiment of the present invention.

When the plurality of first pixels PXa display the complex image and the plurality of second pixels PXb display the simple image, the signal controller 600 first receives the general digital image signal DAT1 corresponding to the complex image for a first half frame T1 of one frame 1FT from the graphics controller (not shown) as the input image signals R, G and B, and receives the input control signal which controls display thereof.

The signal controller 600 processes the general digital image signal DAT1 and sends the processed general image signal DAT1 to the general data driving circuit 520.

The data driving circuit 520 selects gray voltages corresponding to the general digital image signal DAT1, converts the digital general image signal DAT1 into analog general data voltage Vdat1, and applies the converted general data voltage Vdat1 to the data lines D₁ to Dₘ.

The signal controller 600 outputs the scanning start signal LSTV to the first gate driving circuit 400L, and the first gate driving circuit 400L sequentially applies the gate-on voltage Von to the first gate lines Ga₁ to Gaₙ according to the gate control signal CONT1 from the signal controller 600 and turns on the switching elements Qa which are connected to the first gate lines Ga₁ to Gaₙ. Therefore, the general data voltage Vdat1 is applied to the first pixels PXa and the first pixels PXa display luminance represented by the gray levels of the general digital image signal DAT1.

After the first gate driving circuit 400L applies the gate-on voltage Von to the first gate lines Ga₁ to Gaₙ, a predetermined blanking period lapses and the signal controller 600 outputs the scanning start signal RSTV to the second gate driving circuit 400R. The blanking period may be two or more horizontal periods 2H.

During the blanking period, the general data driving circuit 520 is turned off and the simple data driving circuit 530 is turned on. Therefore, the output buffer (not shown) of the simple data driving circuit 530 enters a steady state.

After the blanking period ends, and for a second half frame T2, the signal controller 600 receives the simple digital image signal DAT2 corresponding to the simple image from the graphics controller (not shown) as the input image signals R, G and B.

The simple data driving circuit 530 receives the simple digital image signal DAT2 corresponding to second pixels PXb according to the data control signal CONT2 from the signal controller 600. Then, the simple data driving circuit 530 selects one of the first voltage V1 and the second voltage V2 corresponding to the simple digital image signal DAT2 and applies the selected voltage V1 or V2 to data lines D₁ to Dₘ as the simple data voltage Vdat2.

The second gate driving circuit 400R sequentially applies the gate-on voltage Von to the second gate lines Gb₁ to Gbₙ according to the gate control signal CONT1 from the signal controller 600. Therefore, the simple data voltage Vdat2 is applied to the second pixels PXb and the second pixels PXb display the simple image.

When the simple digital image signal DAT2 is, for example, a one-bit digital signal, the eight (8) colors may be represented with one dot as a combination of three pixels PXb having red, green and blue color filters. With a combination of 8 colors, the simple image, such as a clock display or an operating manual for a device, can be displayed.

In summary, different images can be displayed on the first and the second surfaces of the liquid crystal panel assembly 300 by the pixels PXa and PXb, respectively. The images of the first and second surfaces may have different sizes. According to one exemplary embodiment of the present invention, images are displayed on the first and second surfaces of the display panel, and the blanking period between the display of the one image on the first surface and the display of the second image on the second surface of the display device allows the output buffer of the simple data driving circuit 530 to enter steady state, providing stable display of the two images A blanking period between the first and second periods provides an advantage of a stable display and a simple data driving circuit which supplies the second data signal which provides an advantage of reduced power consumption. Furthermore, the smaller circuit size of the simple data driving circuit 530 relative to the circuit size of general data driving circuit 520 provides the advantage of reduced power consumption of the display device.

While the present invention has been described in connection with what is presently considered to be practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. A liquid crystal display device comprising:
a display panel having first and second surfaces facing each other, a plurality of first pixels which display an image on the first surface and a plurality of second pixels which display an image on the second surface;
a data driver which supplies first data signals to the plurality of first pixels in a first period and second data signals to the plurality of second pixels in a second period; and
a gate driver comprising a first gate driving circuit which supplies a gate-on voltage to the plurality of first pixels in the first period and a second gate driving circuit which supplies the gate-on voltage to the plurality of second pixels in the second period.

2. The liquid crystal display device of claim 1, wherein the plurality of first pixels and the plurality of second pixels are arranged alternately.

3. The liquid crystal display device of claim 1, further comprising:
a plurality of first gate lines connected to the plurality of first pixels; and
a plurality of second gate lines connected to the plurality of second pixels,
wherein the plurality of first and the plurality of second gate lines are arranged alternately.

4. The liquid crystal display device of claim 1, wherein the first data signal comprises a number of values and the second data signal comprises a number of values, and the number of values which the first data signal comprises is not equal to the number of values which the second data signal comprises.

5. The liquid crystal display device of claim 1, wherein at least one of the first and the second data signals comprise at least two values.

6. The liquid crystal display device of claim 1, wherein the data driver comprises:
a first data driving circuit which receives a first image signal, comprising a number of first bits, and generates the first data signal; and
a second data driving circuit which receives a second image signal, comprising a number of second bits, and generates the second data signal.

7. The liquid crystal display device of claim 6, wherein the number of first bits in the first image signal is not equal to the number of second bits in the second image signal.

8. The liquid crystal display device of claim 7, wherein the first data driving circuit selects one of at least three gray voltages and outputs the selected gray voltage as the first data signal, and the second data driving circuit selects one of at least two gray voltages and outputs the selected gray voltage as the second data signal.

9. The liquid crystal display device of claim 8, wherein the first and second data driving circuits comprise output buffers which output the first data signal and the second data signal, respectively.

10. The liquid crystal display device of claim 1, wherein the gate driver further comprises:
an output terminal which sends a carry signal and;
an output buffer which outputs the gate-on voltages to the plurality of first and second gate lines.

11. The liquid crystal display device of claim 1, wherein the first gate driving circuit and the second gate driving circuit are located at opposing ends of the plurality of first and the plurality of second gate lines, respectively.

12. The liquid crystal display device of claim 1, further comprising a blanking period between the first period and the second period.

13. The liquid crystal display device of claim 1, wherein the blanking period comprises at least two horizontal periods.

14. The liquid crystal display device of claim 1, wherein the plurality of first pixels comprise a plurality of transmissive pixel electrodes and the plurality of second pixels comprise a plurality of reflective pixel electrodes.

15. A method of driving a liquid crystal display device, the method comprising:
sequentially supplying a gate-on voltage to a plurality of first pixels;
supplying a first data signal to the plurality of first pixels to display an image on a first surface of a display panel;
sequentially supplying the gate-on voltage to a plurality of second pixels, the plurality of first pixels and the plurality of second pixels being alternately disposed; and
supplying a second data signal to the plurality of second pixels to display an image on a second surface of the display panel.

16. The method of claim 15, further comprising a blanking period.

17. The method of claim 16, wherein the blanking period is at least two times as long as one duration of the gate-on voltage.

18. The method of claim 15, wherein the method of supplying the first data signal to the plurality of first pixels comprises
selecting a gray voltage corresponding to a first image signal from among at least three gray voltages, and
applying the selected gray voltage to the plurality of first pixels as the first data signal; and
the method of supplying the second data signal to the second pixels comprises
selecting a gray voltage corresponding to a second image signal from among at least two gray voltages, and
applying the selected gray voltage to the plurality of second pixels as the second data signal.

19. The method of claim 15, wherein the plurality of first pixels comprise a plurality of transmissive pixel electrodes and the plurality of second pixels comprise a plurality of reflective pixel electrodes.
